(19) United States
(12) Patent Application Publication
(10) Pub. No.: US 2011/0251920 A1
(43) Pub. Date: Oct. 13, 2011

(54) ITEM FINDER SYSTEM FOR FINDING ITEMS STORED IN STORAGE REGIONS

(76) Inventor: Douglas Watson, Nepean (CA)

(21) Appl. No.: 13/082,179

(22) Filed: Apr. 7, 2011

Related U.S. Application Data
(60) Provisional application No. 61/322,007, filed on Apr. 8, 2010.
(60) Provisional application No. 61/379,879, filed on Sep. 3, 2010.

(51) Int. Cl. G06Q 30/00; G01C 21/00

(52) U.S. Cl. 705/26.9; 701/201

(57) ABSTRACT

An item finder system for situating in a retail environment for the purpose of assisting customers to find the items they wish to find has a touch-sensitive display screen. Customers enter the name of the sought item by touching letters displayed on the touch-sensitive surface which then displays a list of item names from what the customer can choose. An item name is selected from the list by touching a graphical symbol associated with the item name. The item finder system responds to the customer's touch by displaying a floor plan or layout of at least part of the store, a marker symbol representing the location of the item, for example, a section of shelf space that contains the item, and a path line extending from the customer's present location, i.e., the location of the touch-sensitive screen, to the location of the item in the store.

### CROSS-REFERENCE TO RELATED APPLICATIONS

This invention claims priority from U.S. Provisional patent application Ser. Nos. 61/322,007 and 61/379,879 filed Apr. 8, 2010 and Sep. 3, 2010, respectively. The entire contents of each of these applications are incorporated herein by reference. Likewise, the entire contents of each of the existing patents and patent applications discussed in the following Background Art section are incorporated herein by reference.

### TECHNICAL FIELD

This invention relates to item finder systems for finding items stored in storage regions, for example retail stores, supermarkets, department stores, warehouses and so on, and is especially applicable to systems for use by customers to find items they wish to purchase in retail stores.

### BACKGROUND ART

It is a common occurrence that shoppers are unable to find items in stores. This problem is especially prevalent in large stores where the items are numerous, are spread over a large area and are hidden from the direct view of the customer. Stores of all types, including grocery stores, hardware stores and department stores, have not provided an effective method of directing customers to the items in the store. Increasingly, stores have relatively few staff who might be able to answer queries and direct customers to the items. Many stores attempt to alleviate this problem by providing signs, for example over the aisles, to identify the category of goods in particular areas of the store, but this method is not effective because the customer is unable to see and read all the signs from one location. Thus the customer must search the store to find a sign that guides him/her to the vicinity of the item. In addition, the signs usually have a limited amount of space that is available for printed text, so it is not possible to list all the items that can be found within a particular section of the store.

Many attempts to solve the problem have been made over the years. For example, U.S. Pat. No. 2,808,579 (McCarthy) issued October 1957 discloses a system for identifying the locations of items on shelves which comprises a display panel containing a list of the items, each item on the list having a selector button which the customer may press to illuminate an indicator showing the item location relative to a layout of the store. This approach is simple but the number of items listed is limited by the area of the display and there must be a separate selector button for each item; hence it would not really be suitable for use in modern stores which generally carry many items. Even if there were space to increase the number of items, it would be very time-consuming to scan through them to find the item of interest.

During the fifty years or so since U.S. Pat. No. 2,808,579 was granted, many other inventors have sought to find an effective solution to the problem of finding items in stores. Examples of known item finder systems are disclosed in U.S. Pat. Nos. 6,813,341 (Mahoney) and 7,292,678 (Glynn et al.) and PCT application No. WO2009/149340. Each of them is voice-activated, i.e., a user utters the name of the required item into a microphone and the system uses a speech recognition module to identify the name of the item and speech generation and/or a visual display to output the location of the item to the user/customer. Many customers are not fluent in the language of the country, and may have heavy accents, so it is extremely difficult for a speech recognition module to interpret the speech of many different customers with an acceptably high level of accuracy, especially in the presence of background noise which is relatively high in a typical supermarket or other retail store.

The system disclosed in WO2009/149340 also enables the user to access the system using a telephone, further increasing complexity and concomitant cost. Also, not all customers, especially the elderly, own a mobile telephone and would be comfortable using such a device to search for items in a store. Yet older people are those most likely to need to use an item finder system because they are more susceptible to memory lapses.

United States Published Patent applications Nos. US 2008/0301102A1, US2004/0103031A1 and 2002/0065714 A1 disclose location systems that comprise a keyboard, a computer and a computer monitor, in at least one case assembled in one or more kiosks at access points to the store. The customer types the names of desired items using the keyboard. US2008/0301102 optionally provides voice input too. The computer searches through a database to find the item name and the location of the item in the store. The location of the item relative to a floor plan of the store is displayed on a computer monitor. In the case of US2008/0301102, a path from the kiosk to the item location is shown as a broken line (FIG. 3). It would be desirable for a store to have item locator systems distributed throughout the aisles, preferably shelf-mounted, so the systems of US2008/0301102A1, US2004/0103031A1 and 2002/0065714 A1 would be unsuitable because they would be too bulky. Other disadvantages of these systems lie in the method used to input the item names and/or display the graphical information to the customer. US2002/0065714 complicates the path generation by requiring customer identification to be entered and then diverting the customer past other item locations in the expectation that the customer might be enticed into buying other items en route, which some customers might find annoying.

U.S. Pat. No. 7,537,156 entitled Fly-Around Product Locator and United States Patents 20080017708 and 20060283941 of the same title each describe a system for finding items in stores which uses a wireless connection between a central transmitter device and a customer-held wireless receiver. An image of the scene directly ahead of the customer is displayed for the purpose of guiding the customer to the item. This would not be entirely satisfactory for the same reasons discussed above, namely complex and expensive technology, which would mitigate against using item finder systems at many strategic positions throughout the store and also might intimidate customers, especially the elderly, who were not comfortable with such high technology devices.

U.S. Pat. No. 6,757,999 discloses a system for identifying the location of items on shelves which comprises a central chart containing a list of items with an associated code for locating the items on shelves. The system is primarily intended for stocking the shelves with the items and requires the user to consult a centrally located chart and read the code that identifies the location of the item. Such a system is not entirely satisfactory for helping a customer unfamiliar with technology, or the item identifiers used in a particular store, for example a retail store, in which items are to be located.

U.S. Pat. No. 7,158,878, assigned to Google Inc., discloses a system for overlaying route information onto a map image. The overlaid information includes the position of a particular point on the map and a route leading to the point. The system is relatively complex, involving the selection of a set of map tiles having (x,y,z) coordinates and which have to be assembled into a tile grid which then is aligned to a so-called clipping shape before the map is displayed. The direction of the route is determined, then the route is computed and overlaid upon the map. This complex system is typically used to assist travelers in finding a destination and is not really suitable for item finder systems for use by customers to find selected items in a store.

Generally, therefore, known item finder systems tend to have limited capacity, or are too bulky, or are very complex and, hence, not only expensive to make but also not particularly easy to use, especially by a customer who is not familiar with or comfortable using modern communications devices, as is the case with some elderly customers.

### SUMMARY OF INVENTION

The present invention seeks to eliminate, or at least mitigate, the disadvantages of the known systems described above and has for its object to provide a new item finder system for finding items in a storage region, or at least provide an alternative.

In this specification, the term “storage region” is used, for convenience, to include retail stores, supermarkets, department stores, shopping malls, predefined tourist areas or heritage areas, and so on, where a customer may wish to identify the location of an item of interest. It also includes warehouses.

According to one aspect of the present invention, there is provided an item finder (10) for assisting users to find items stored in a prescribed storage region comprising:

(i) a touch-sensitive input-output display unit (12) for displaying, in an input mode, at least a pattern (20) of touch-sensitive letters for entry of letters by a user and, in an output mode, a listing of items each beginning with at least one letter entered by the user;
(ii) either or both of means for storing data locally and means for accessing remote data storage means storing data, the data representing
(ii)(a) a floor plan or layout (40) of at least part of the storage region,
(ii)(b) a listing of names of items stored in the storage region associated with their respective item locations in the storage region,
(ii)(c) a predetermined installed location of the touch-sensitive input-output display unit itself, and
(ii)(d) a plurality of paths each extending between the installed location and a respective one of the item locations;
   (iii) processing means coupled to said touch-sensitive input-output display unit and programmed for
(iii)(a) controlling the touch-sensitive input-output display unit to display one or more input screens in succession to prompt the user to touch the pattern of letters to enter at least one letter to begin spelling the name of the item sought,
(iii)(b) detecting entry of said letter by the user and, in response, accessing the stored data to select a shortlist (28) of item names each beginning with that letter and displaying said shortlist on the screen;
(iii)(c) detecting whether the user inputs one or more additional letters or selects one of the short listed item names by touching a specified area of the screen,
(iii)(d) if the user subsequently enters one or more additional letters, as each letter is entered, accessing the stored data and displaying a revised shortlist of item names each beginning with the sequence of letters entered by the user until either the user has spelled an item name that is not available or the user selects one of the short-listed item names;
(iii)(e) if the user selects a short-listed item name, accessing the stored data to select data for a respective one of said plurality of paths that extends between said installed location an item location of the item whose name has been selected;
(iii)(f) combining the data representing said selected path with the data representing the floor plan or layout; and
(iii)(g) causing the touch-sensitive input-output display unit to display said floor plan or layout with the selected path superimposed or overlaid upon the floor plan or layout.

The item finder system may comprise a housing accommodating both storage means for storing said stored data and the processing means. Additionally or alternatively, the item finder system may have means for accessing remote storage means storing said stored data. In preferred embodiments, the item finder comprises a suitably-programmed tablet computer.

Preferably, the item finder system is suitable for mounting upon a shelf, bracket or other convenient support within the store, conveniently at the beginning of an aisle between shelves or along an aisle.

According to second aspect of the invention, there is provided a method of finding items in a store, especially in a retail store, using a computing device having a touch-sensitive input-output display unit (12), either or both of means for storing data locally and means for accessing remote data storage means storing data, and processing means, the stored data representing
(ii)(a) a floor plan or layout (40) of at least part of the storage region,
(ii)(b) a listing of names of items stored in the storage region associated with their respective item locations in the storage region,
(ii)(c) a predetermined installed location of the touch-sensitive input-output display unit itself, and
(ii)(d) a plurality of paths each extending between the installed location and a respective one of the item locations;
   the method comprising the steps, by the processor, of:
(iii) controlling the touch-sensitive input-output display unit to display one or more input screens in succession to prompt the user to touch the pattern of letters to enter at least one letter to begin spelling the name of the item sought,
(iii)(b) detecting entry of said letter by the user and, in response, using the detected letter to access the stored data to select a shortlist (28) of item names each beginning with that letter and displaying said shortlist on the screen;
(iii)(c) detecting whether the user inputs one or more additional letters or selects one of the short listed item names by touching a specified area of the screen,
(iii)(d) if the user subsequently enters one or more additional letters and the total letters do not spell the item name, as each letter is entered, using the letter to access the stored data and select a revised shortlist of item names each beginning with the sequence of letters entered by the user and displaying the revised shortlist;
(iii)(e) detecting whether or not the user has spelled an item name that is not available or the user has selected one of the short-listed item names by touching the screen;
(iii)(f) if the user selected a short-listed item name, accessing the stored data to select data for a respective one of said plurality of paths that extends between said installed location an item location of the item whose name has been selected;
(iii)(g) combining the data representing said selected path with the data representing the floor plan or layout; and
(iii)(h) causing the touch-sensitive input-output display unit to display said floor plan or layout with the selected path superimposed or overlaid upon the floor plan or layout.

If the full name has been entered and the item is not available, the processor may return to the input screen and prompt for a new item to be found, either (a) in response to the customer touching/selecting a designated spot, for example a “Search for new Item” button, or (b) after a specified time delay (time out) during which the screen has not been touched (e.g., the customer walked away).

Where step (iii)(e) detects that the user had spelled the name of an item which was not available, the method may further comprise the step of storing the item name in the storage means and with an indication that it was sought by a user unsuccessfully. Such a step enables the unavailable items to be considered for adding to the stock of items sold and the stored data updated as appropriate. The item finder may display a prompt, e.g., “Touch Here to request a new item”, to input the name of an item the customer could not find.

In general, a customer in a store does not need to know the precise location of a particular item. Consequently, in preferred embodiments of the invention, the item locations are identified as shelf sections, for example for foodstuffs, or floor areas, for example for large items not usually displayed on shelves, or other general locations which may be shared by several different items. Because several items may share the same item location, the stored data may be less than would be required if every item had a unique item location or “address” in the system.

In consequence, the number of paths from a given position of the input-output display unit to the respective item locations will be fewer, so the stored data for each position of the input-output display unit may comprise a plurality of image files, each for generating an image of the respective path, and the processing means may combine the selected image file with an image file for generating the at least part of the store plan or layout, and display a resulting image which shows the selected path superimposed or overlaid upon at least part of the store plan or layout.

Storing individual path images may simplify the storage, selection and merging operations. Thus, the stored data may simply comprise the names of the items and, associated with each item, an identifier corresponding to the item location where that item should be found. Preferably, the identifier comprises a software pointer to the image file used to generate the image of the path to the item location associated with that item.

In embodiments of either aspect of the invention, the item names may be grouped according to item location, i.e., for each item location identifier there will be a list of names of items in that item location.

Alternatively, the short-listed items may be stored, selected and displayed in alphabetical order.

In general, the number of items beginning with the same two or three letters will be relatively small, so a user usually will not need to spell the entire name of the item in order for the processor to generate the short-list of item names containing the desired item name; or determine that it is not available.

Although the storage means preferably is located within the same housing as the input-output display unit, it could be located elsewhere and accessed using suitable communications technology, such as wireless networking technology.

The foregoing and other objects, features, aspects and advantages of the present invention will become more apparent from the following detailed description, taken in conjunction with the accompanying drawings, of preferred embodiments of the invention, which description and drawings are provided by way of example only.

### BRIEF DESCRIPTION OF DRAWINGS

In the drawings, identical or corresponding elements in the different Figures have the same reference numeral.

FIG. 1 illustrates an item finder system embodying this invention mounted upon shelving in a store and having a touch-sensitive screen;

FIG. 2 depicts the image displayed on the touch-sensitive screen of the item finder system during an input mode;

FIGS. 3A and 3B illustrate item name data stored in memory means of the item finder system;

FIG. 4 illustrates a screen image of a path between the installed location of the item finder system and a selected item location;

FIG. 5 illustrates a screen image of a floor plan of the store with the path image of FIG. 4 superimposed upon it;

FIG. 6 is a flow chart illustrating a sequence of events when the item finder system is being prepared for use and, subsequently, used by a customer to find an item location;

FIG. 7 is a flow chart illustrating operation of a microprocessor of the item finder system during use by a customer to obtain the location of an item;

FIG. 8 is an illustration of an application of the item finder system in a shopping facility comprising a plurality of stores;

FIG. 9 is an illustration of an application of the item finder system in a municipality comprising a plurality of retail stores;

FIG. 10 corresponds to FIG. 2 but shows the image displayed on the touch-sensitive screen of a modified item finder system; and

FIG. 11 depicts the image subsequently displayed on the touch-sensitive screen of the item finder system when the user touches a “Touch Here” button shown in FIG. 10.

### DESCRIPTION OF PREFERRED EMBODIMENT

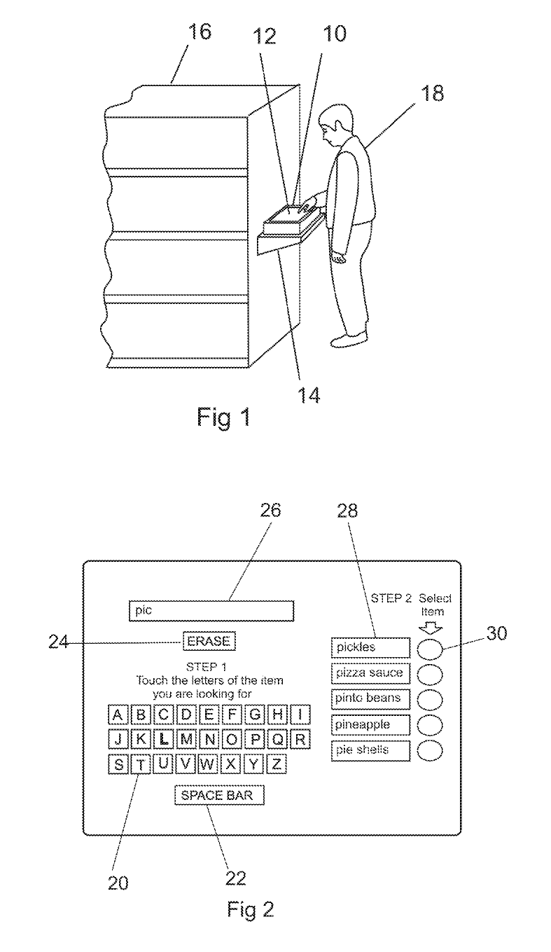

FIG. 1 illustrates an item finder system 10 comprising an input-output display unit 12, specifically a touch-sensitive screen, mounted on a bracket 14 attached to the endwall of shelving 16 carrying items that are available for sale. A store customer 18 is shown with an index finger touching the screen. The item finder system will also comprise electronic circuitry, including processing means, such as a microprocessor, for detecting user input via the touch-sensitive screen, accessing a data storage memory means, conveniently co-located with the microprocessor, and outputting information to the customer by supplying drive signals to the input-output display unit causing the touch-sensitive screen to display selected images. It will also include a suitable input means for inputting data to the data storage memory means, if internal, using known data transfer means, for example a USB drive, a wired network connection, a wireless network connection (e.g., Bluetooth®, Wi-Fi, WiLan), and so on.

The touch-sensitive screen may be of any suitable known design having a touch-sensitive mat overlying a display screen, for example an LCD panel. The input-output display unit will have means for detecting the coordinates of a spot touched by the customer and correlating them with the underlying graphics artefact, the microprocessor being programmed to take appropriate steps in response. As is usual, the graphics artefacts will represent physical analogues, such as touch-sensitive letters, window, pushbuttons and space bar. For clarity and convenience, the following description will refer to the physical analogues rather than the graphics artefacts.

FIG. 2 shows a first screen image which will be displayed to the customer during an input mode, i.e., when the customer is entering information to select an item. The screen image comprises a pattern of touch-sensitive letters 20 together with a space bar 22 and erase/delete button 24, a text window 26 for showing letters as they are selected by touching the pattern of letters, a column of five text windows or boxes 28 for showing names of a shortlist of items beginning with letters entered so far, and a column of five item selection pushbuttons 30, each alongside a respective one of the item name boxes 28.

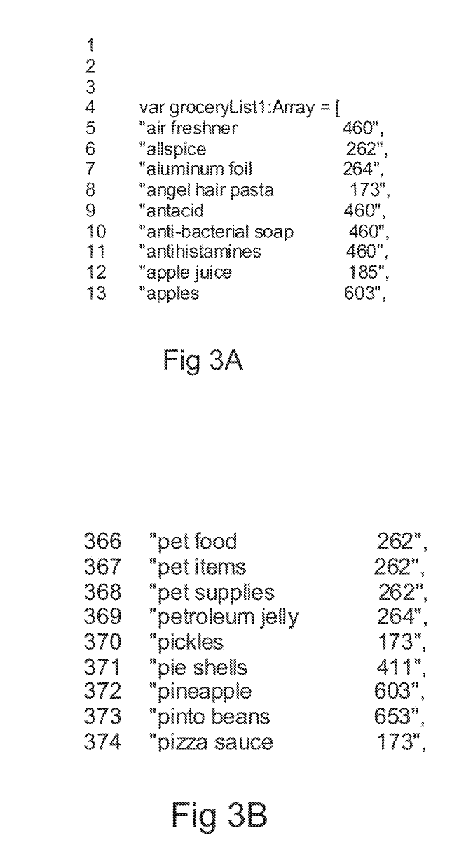

FIGS. 3A and 3B are examples of extracts from a data array stored in the data storage means that is accessed by the microprocessor. The entire data array lists the names of all items for sale in the store, each associated with a number associated with a physical item location, for example a shelf section. Each number is actually an identifier, for example a software pointer, linking to an image file which will generate an image of a path between the predefined installed physical location of the item finder system and an item location where the associated item should be located. Hence, the stored data will also include an image file for generating a store plan/layout and a set of image files for generating images of a set of paths all beginning at the same predefined physical location of the item finder system 10 which will have been determined when the item finder system was being installed. Although the set of paths all begin at the same location, each path in the set will be unique because it will end at a different item location. Conversely, if several item finders are installed, which may be desirable in a larger store, each at a different location in the store, they will share not only the same floor plan or layout but also the array of item names and item locations. However, there will be a unique set of paths for each item finder because, although all of the paths will end at a respective one of the item locations, the starting point will depend upon the installed location of the corresponding item finder, which will generally be unique.

It should be noted that several of the item names in the data array, for example air freshener, antacid, anti-bacterial soap, antihistamines, “share” the same item location identifier number, the reason being that several different types of item may be located in the same section of shelving, or in the same floor area.

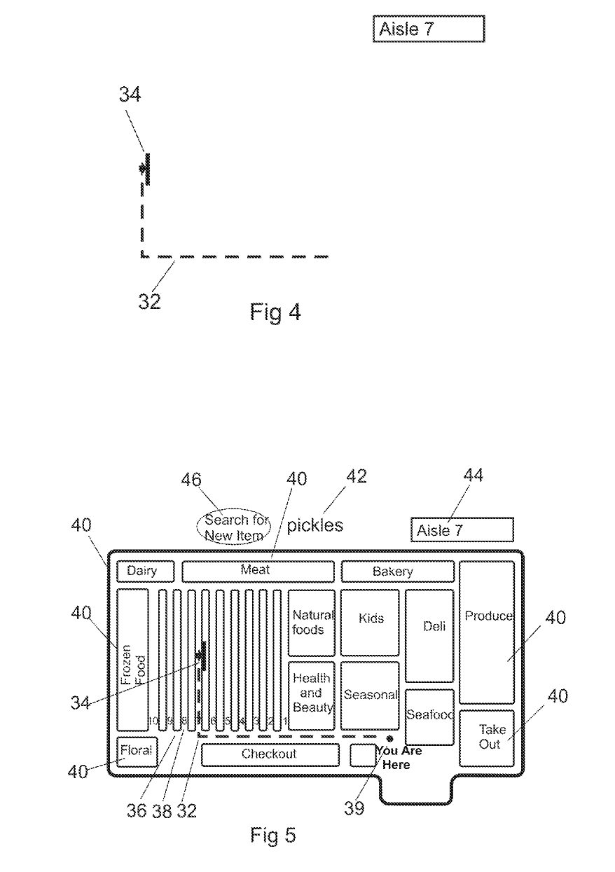

FIG. 4 shows, as an example, a screen image of a path comprising a broken line 32 with the associated item location shown as a thick bar 34 at one end, i.e., the “finish” end. The other end, the “start” end, has no special ending because it will coincide with the installed location of the item finder system which will be identified by a marker symbol based upon the coordinates inputted when the item finder is installed and set up.

Referring again to FIG. 2, if, when a new customer begins to use the item finder system, the text window 26 contains letters entered by a previous customer, the new customer may use the erase button 24 to erase the letters in window 26 and begin to enter (spell) the name of the item he/she wishes to purchase, whereupon the processing means will change the displayed item names in boxes 28 to something appropriate, as will be described later. (The system software may incorporate a time-out to erase entered letters and, perhaps, item names after a predetermined interval during which no entries have been made.) The customer may, of course, use the erase/delete button 24 to change his-her own entries, perhaps to use a different name for the same item or simply to search for the location of another item.

FIG. 2 actually shows the screen image after the customer has entered the three letters “p-i-c” by touching those letters in the pattern of touch-sensitive letters 20. The three letters are shown in entered letters window 26 and the item name boxes 28 show the names of a shortlist of five item names beginning with “pickles”. In fact, that is the only item beginning with all three letters. The other four items, namely pizza sauce, pinto beans, pineapple and pie shells, begin with only the first two letters “p-i”. It will be noted that the short-listed items are listed in alphabetical order starting at the bottom of the list. Since there is only one item name in the array starting with p-i-c (see FIG. 3B), “pickles” was the only short-listed item name with those letters. If the customer selects one of the listed item names, by touching the virtual pushbutton 30 next to the selected item name, the processor will switch the display from input mode to output mode, and access the stored data to obtain the data file for the path beginning at the installed location of the item finder system 10 and ending at the item location associated with that selected item name. The processor will merge the selected path data file and the floor plan/layout data file, together with the YOU ARE HERE icon or marker showing the installed location, and cause the touch-sensitive screen to display the combined image instead of the input screen shown in FIG. 2. It will be appreciated that the data for the installed location will have been entered when the item finder was installed and could be linked to the floor plan/layout data. Of course, since the set of paths is unique to that installed location, the data for the installed location marker and YOU ARE HERE tag could be associated with each of the image files for the set of paths unique to that installed location. It should also be noted that the installed location could itself be an item location, especially if the item finder is mounted upon one of the shelves.

FIG. 5 shows the output screen image comprising the store floor plan/layout which show rows of shelves 36 with intervening numbered aisles 38 which might stock food and general housewares, for example, with several rectangular areas 40 representing refrigerated displays, floral areas, produce display racks, an area where items are displayed on tables, and so on. Superimposed upon the store plan/layout is the path image 32/34. The floor plan includes a large spot and the words YOU ARE HERE, representing the installed position of the item finder system. If several of the item finder systems are installed in the store, they may share the same floor plan/layout but the position of the YOU ARE HERE spot will be different for each item finder, each of which will have its own unique set of path images.

As mentioned, there will be a set of path images for that particular installed location, each having a “start” end coincident with its installed location i.e., the spot 39. If the item finder system is moved to another installed location, data for a different set of image paths beginning at the new location will need to be entered (if not already entered as an alternative at the outset). Likewise, if several similar item finder systems are installed at various installed locations throughout the store, each will have a different set of image paths having a common starting point for its own paths

The microprocessor merges the path image data file with the floor plan/layout data file, in such a way that the path is registered to the store plan/layout so that, when displayed in the combined image, the “start” end of the path coincides with the YOU ARE HERE spot 39 and the item finder bar 34 at the “finish” end of the path registers with the location of the item, in this case a shelf about halfway along aisle number 7 on the right hand side. Also, the path lines follow the aisles and other passageways of the store.

For convenience, the combined screen image shown in FIG. 5 also shows, in boxes 42 and 44, respectively, the name of the item (pickles) that has been selected by the customer and the number of the aisle or department where the item is located. The image also includes a box 46 containing the words “Search for New Item” which the customer can touch to begin searching for a new item. When the customer touches the box 46 to begin searching for a new item, the microprocessor reverts to displaying the “item name entry” screen shown in FIG. 2.

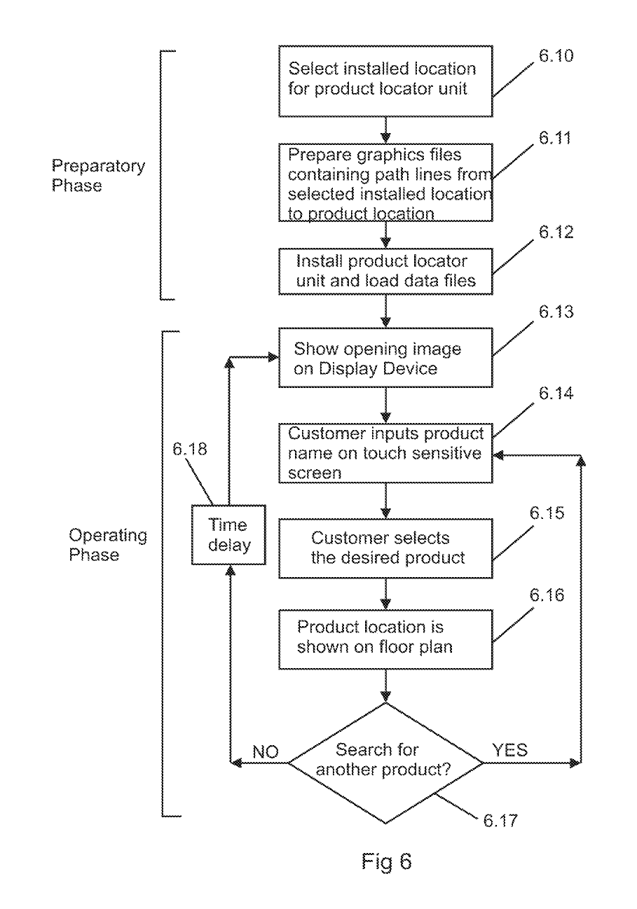

FIG. 6 is a flow chart which shows the sequence of events that occur during the preparatory phase, when the item finder is installed at a selected location, and the subsequent operating phase of the item finder system. Steps 6.10, 6.11 and 6.12 depict steps taken before the item finder system can be used; it must be loaded with data specific to its location when installed in the store. The data will include an image file for generating the floor plan of the store, or at least part, e.g. an appropriate section or floor, of the store, plus a set of image files for generating, selectively, the set of paths to the desired item locations.

The format of the data in the array that contains the names of the items is that shown in FIGS. 3A and 3B. The files are registered to each other so that, when the image files containing images of path 32 and location bar 34 are overlaid on the floor plan of the store, they accurately show the location of the particular item that has been selected by the customer and the path the customer may take to reach it. If item finder systems are installed at more than one location in a store, a set of path image files is prepared for each installed location.

Steps 6.13 to 6.17 of the flowchart depict in general terms the operation of the item finder system as perceived by the customer. Thus, once the item finder system has been loaded with data, its processor displays an opening image on the touch sensitive surface (Step 6.13). Step 6.14 illustrates an action of a customer who inputs the letters of an item name by touching letters on the touch sensitive surface. Step 6.15 represents the customer action of selecting the name of an item that the customer wishes to purchase. The item name is selected from a list of item names that are displayed in response to touching letters (in Step 6.14). In Step 6.16, the processor causes the input-output screen to display a floor plan of the store as in FIG. 5, bar 34 representing the location of the selected item, a section of shelf space that contains the item, an aisle or department location 44, the name of the selected item 42 and a path line between the customer's present position (i.e., the location of the item finder system) and the location of the item. In Step 6.17, the customer is prompted to choose search for another item. If the customer chooses to search for another item, he/she touches “button” or box 46 of FIG. 5, as in step 6.17. The display changes to permit another item name to be entered as illustrated by Step 6.13. If, at step 6.17 the customer chooses to walk away, the display remains unchanged until a computer programmed time delay (time-out), 6.18 initiates a means for changing the display to show the opening image again as illustrated by Step 6.13.

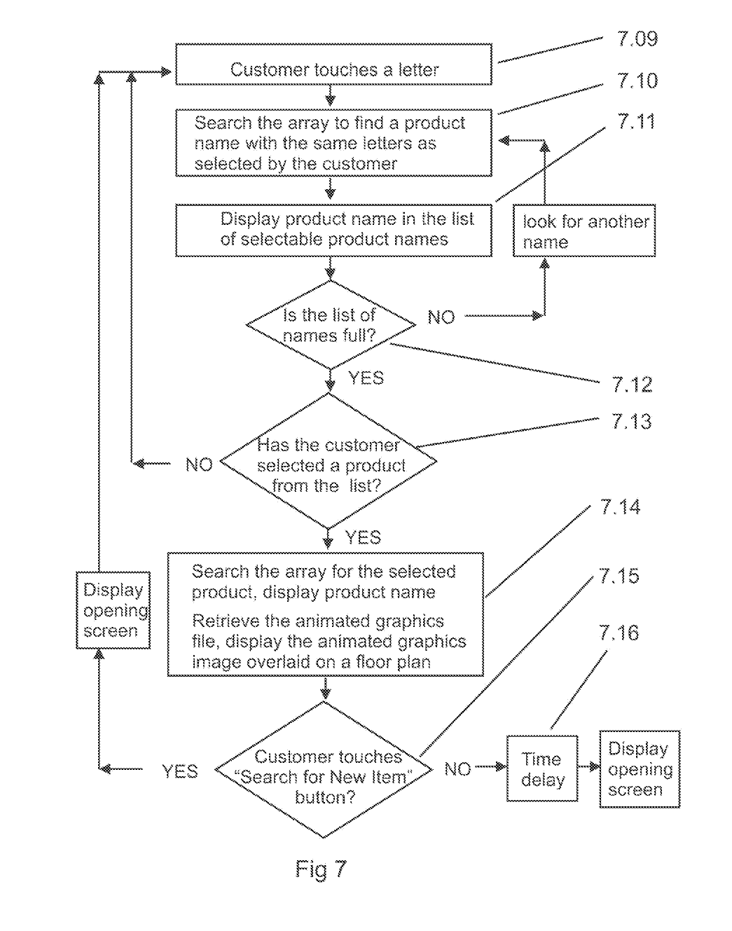

FIG. 7 is a flow chart showing operation of the item finder system in terms of the computer operations that are performed by the processor when it detects, in step 7.09, that a customer has begun to enter an item name on the touch sensitive surface. Step 7.10 represents the searching of an array (FIGS. 3A, 3B) to find an item name with the same letter sequence as the letters being inputted by the customer. Step 7.11 represents the display of the found item name in one of the boxes 28 and the elimination of that name from the next search iteration. Step 7.12 represents repeated search iterations until a complete shortlist of items has been displayed. Step 7.13 represents detection of the customer's choice whether or not to select one of the items listed in one of the boxes 28. If the customer does not select an item from boxes 28, the computer program waits for another letter to be touched. If the customer selects an item from boxes 28 as illustrated by step 7.14, the microprocessor searches the array to find the selected item name and its appended section identifier, then retrieves and displays the animated graphics image that has a filename that is the same as the section identifier. This file contains the graphical information that is overlaid on the image of a floor plan to show the location of the selected item. Step 7.15 represents the detection of the customer's choice whether or not to search for a new item by touching item 46. If the customer's choice is to search for a new item by touching item 46 in which case, the display changes to show the opening screen as illustrated in FIG. 2 and the customer can then proceed to enter letters in letter pattern 20. If the customer chooses to walk away, the display remains unchanged until a time delay step 7.16 has reached its preset limit and initiates an action in the microprocessor to change the display configuration to the configuration shown in FIG. 2.

The item finder system may incorporate features that are designed to draw the customer's attention to the most significant aspects of the displayed information. Display features may be given special attributes to attract the customer's attention. These attributes may include flashing of display features on and off, highlighting the feature with bold coloring, changing the size of the feature, motion of the displayed images or acoustic effects including voice. Features that may use this method of display include but are not limited to the following: location marker symbol 34, path line 32, and aisle or department identification 44. The item finder system may use visual and audible feedback to verify that a finger touch has been detected.

### Explanation of Operating Features

An explanation of the operation of the item finder system will now be presented. The names of all items available for sale in the store are stored in a computer within the item finder system in the form of an array. As the customer enters each letter of an item name by touching a letter on touch sensitive surface 12 the array is interrogated using a computer code commonly referred to as a for loop. The sequence of letters that have been typed is compared with the letter sequences of item names in the array. When an item name with beginning letters that match the letters that have been entered into box 26 is found, the item name is displayed (short-listed) in one of the boxes 28. The first matching item name is eliminated from subsequent iterations and the process is repeated until all of the boxes 28 have been filled with selectable item names.

Referring again to FIG. 5, item 40 is an image of the floor plan which is stored in the memory of a computer. Computer files containing graphical images of location marker symbol 34, a path line 32 and an aisle or department location are stored in memory in the form of an array within the computer. Each item location as illustrated by item 34 typically contains a plurality of different items for sale (though it might contain only one kind) and is identified by a number or sequence of letters or a combination of letters and numbers. The names of all the items that reside at an item location have the same identifier appended to the item name in the array as illustrated in FIGS. 3A and 3B. When an item is selected by touching item selection “button” 30, the processor searches the array of item names to find an item name that matches the selected item name. The animated image files containing the location marker symbols 34, path lines and aisle or department location are named with numbers or a combination of letters and numbers that are the same as the identifier appended to the item name as shown in FIGS. 3A and 3B. When the computing device finds the selected item name in the array, the appended identifier is read and the processor retrieves the image file that has the same name as the identifier appended to the item name. The retrieval of the file with the same name as the item name identifier results in the display of the graphics image that shows the location of the item overlaid on a floor plan of the store.

The item finder system may use more than one array in order to accommodate large numbers of items and maintain a satisfactory speed of response when the touch sensitive surface is touched. For example, two arrays may be used, each containing approximately 50% of the item names which are sorted by alphabetical order. Programming code detects the letter sequence of the item name being entered by the customer and directs computations to be performed by the array that contains item names with the same sequence of letters.

Preferred embodiments of this invention are intended to be used in retail stores such as supermarkets, grocery stores, hardware stores, department stores, book stores, pharmacies and sporting goods stores, and in warehouses. Additional applications for embodiments of the invention include shopping centers and commercial districts to assist customers to locate one or more stores within the shopping center that carry the particular item that the customer wishes to buy.

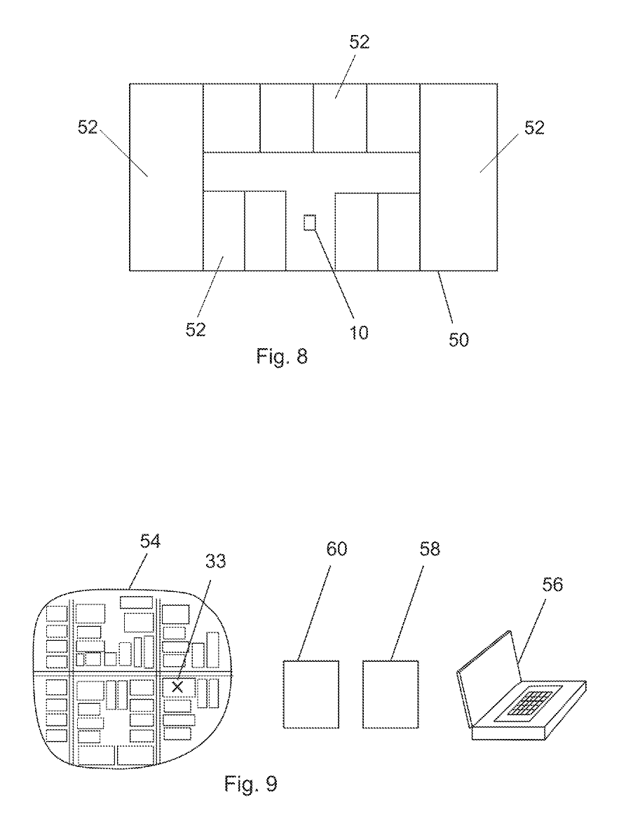

FIG. 8 illustrates an installation of the item finder system 10 in a shopping facility 50 comprising a plurality of stores 52. In this illustration the item finder system is installed at a central location within the shopping facility. When a customer enters the name of an item into the item finder system, the location of the item is found by searching through items that are available in all of the stores in the shopping facility. When the desired item is found, an image is displayed showing the location of the store that sells the item. A floor plan of the store is displayed to further assist the customer in finding the item. The floor plan is overlaid with a path line 32 and a bar 34 marking a section of shelf space where the item is located.

FIG. 9 illustrates an adaptation of the item finder system to a commercial district 54 comprising a plurality of stores where users can search for a store that has a particular item for sale. In this instance users with a home computer or mobile device 56 with Internet capability carry out the search operation on a website. A home computer or mobile wireless device 56 with Internet capability connects via an Internet connection 58 to a website 60 linked to an item finder system situated at a central computing facility. Users enter the names of the desired item on the website. The item name is inputted into the item finder system. The user views the images illustrated by FIGS. 2 and 5 by remotely accessing the internal computer of the item finder system through the Internet connection. The item finder system is configured to display the name and address of the store that carries the item, a map of the region and a location marker symbol item 33 showing the location of the store within the region. A floor plan of the store item 40, a location marker symbol item 34 and a path line item 32 may be provided as an optional feature. In this case, the item finder system would comprise the computing facility connected to website 60.

The data stored in the item finder system may be installed initially, and updated periodically (if an item is moved to another location, no longer stocked, an out-of-stock item is now in stock, an item sought by a customer but not stocked at that time has been added to the inventory, and so on), using any suitable data transfer technology; for example, using a wireless data connection; by data transfer from a portable memory device (USB, smartcard, and so on) plugged into a suitable port, or from another computer using a wired connection or using a wireless transmission protocol (e.g., LAN, WILAN, Wi-Fi), via an Internet connection (wired or wireless). The data may be stored in the main memory of the item finder system or in a portable memory device, such as a USB drive inserted into a USB port.

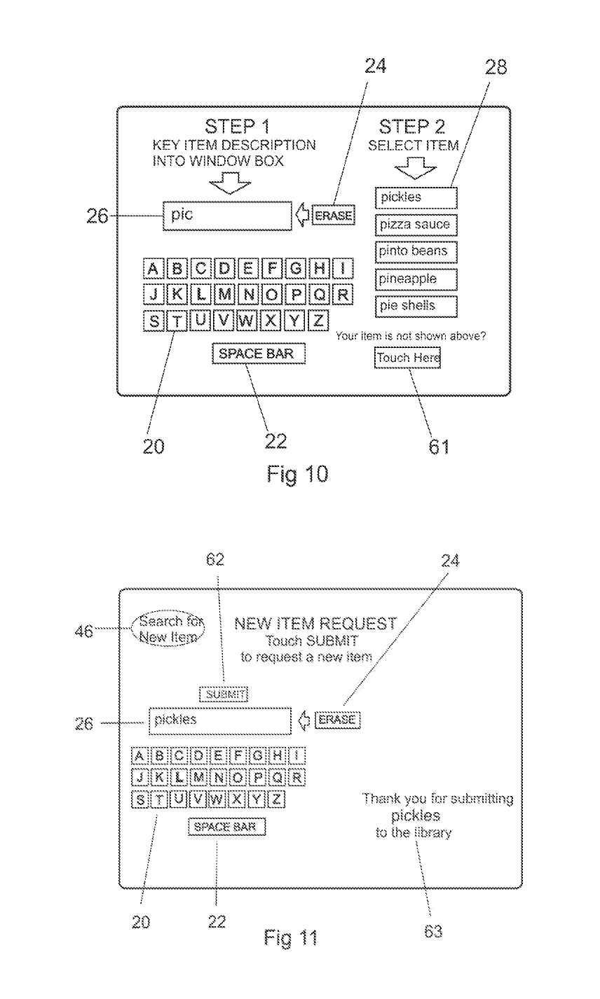

FIG. 10 illustrates the image displayed on the touch-sensitive screen 12 of a modified configuration of the item finder system, which permits the user to select an item name by touching directly on the name of the item in item list 28 instead of touching a separate button 30 (FIG. 2). The screen image shown in FIG. 10 includes a button 61 which the user is encouraged to touch if the sought item was not found/displayed.

FIG. 11 illustrates the display screen which appears when the user is unable to find an item and touches the “Touch Here” button 61 in FIG. 10. This screen enables the user to touch the letters in pattern 20 to enter the name of the item that was not found and submit the name by touching the “SUBMIT” button 62. The item name then is recorded in the memory of the computer and can be accessed at a later time by personnel. If the item is in the store, the name can be added to the library of names in the memory of the item finder system; hence the library will gradually become more complete and the service to customers will improve. When “SUBMIT” button 62 is touched, a message 63 is displayed and the screen returns to the configuration illustrated in FIG. 10.

The image shown in FIG. 11 also includes a box 46 containing words “Search for New Item” (as in FIG. 5) which the customer can touch to begin searching for a new item. When the customer touches the box 46 to begin searching for a new item, the microprocessor reverts to displaying the “product name entry” screen shown in FIG. 10.

Modification of the software of the item finder system to implement the modifications required to enable the functions and operations implied by the screen images of FIGS. 10 and 11 is well within the common general knowledge of those skilled in this art and so is not described in detail here.

It is envisaged that the item finder system could comprise a suitably-programmed tablet computer, for example an iPad (Trademark), Playbook (Trademark) or other microcomputer device having a touch-sensitive screen for input of instructions and wired or wireless connectivity enabling it to be connected to an external computer via a local area network and/or the Internet to allow the stored data to be updated and user input data collected remotely. The programming of such a computing device will not be described in detail because it should be straightforward for a person skilled in this art to do it. In a practical embodiment, Adobe Flash Action Script 3 (Trademark) by Adobe Systems Incorporated, was used to program the item finder, but an alternative object-oriented programming language or other program could be used instead, if desired. Any suitable remote access software could be used to enable stored data to be updated and “item not found” data, for example, to be retrieved from a remote location. Examples are Anyplace Control (Trademark) by Anyplace Control Software of Europe and Remote Desktop Connection (Trademark) by Microsoft.

It is also envisaged that, where several item finder units are deployed in the same storage region, they might be networked, with at least some of the stored data stored on one of them, or a file server computer, and accessed as needed from each user-operated device. For example, shared data, such as the floor plan or layout, the item locations and the list of item names, might be stored on the file server computer and the data unique to a particular item finder, namely its unique location relative to the floor plan or layout (i.e., its coordinates) and its unique set of paths linking its unique installed location to each of the various item locations listed on the file server. A person skilled in the art would be able to set up such a networked configuration without specific instructions so it will not be described in detail herein.

### INDUSTRIAL APPLICABILITY

Advantageously, embodiments of the present invention may be relatively inexpensive to make and simple to use, so many of them can be installed at different convenient locations throughout the store. Preferably, there will be so many of the item finder systems that, if the customer is distracted by other items along the way, and forgets the remainder of the path to follow, there will be another item finder system close by. Because the search process is simple, using a few letters to obtain a shortlist and then selecting a desired item from the shortlist, repeating the search at another item finder would not greatly inconvenience the customer. In fact, the procedure would be similar to that used by people seeking directions from another person, whether in a store or elsewhere, namely; ask a first person (e.g., store employee) for directions and, when close to the item location, ask another person for further directions.

Although embodiments of the invention have been described and illustrated in detail, it is to be clearly understood that the same are by way of illustration and example only and not to be taken by way of limitation, the scope of the present invention being limited only by the appended claims.

1. An item finder (10) for assisting users to find items stored in a prescribed storage region comprising:
(i) a touch-sensitive input-output display unit (12) for displaying, in an input mode, at least a pattern (20) of touch-sensitive letters for entry of letters by a user and, in an output mode, a listing of items each beginning with at least one letter entered by the user;
(ii) either or both of means for storing data locally and means for accessing remote data storage means storing data, the data representing
(ii)(a) a floor plan or layout (40) of at least part of the storage region,
(ii)(b) a listing of names of items stored in the storage region associated with their respective item locations in the storage region,
(ii)(c) a predetermined installed location of the touch-sensitive input-output display unit itself, and
(ii)(d) a plurality of paths each extending between the installed location and a respective one of the item locations;
(iii) processing means coupled to said touch-sensitive input-output display unit and programmed for
(iii)(a) controlling the touch-sensitive input-output display unit to display an input screen to prompt the user to touch the pattern of letters to enter at least one letter to begin spelling the name of the item sought;
(iii)(b) detecting entry of said letter by the user and, in response, accessing the stored data to select a shortlist (28) of item names each beginning with that letter and displaying said shortlist on the screen;
(iii)(c) detecting whether the user inputs one or more additional letters or selects one of the short listed item names by touching a specified area of the screen,
(iii)(d) if the user subsequently enters one or more additional letters, as each letter is entered, accessing the stored data and displaying a revised shortlist of item names each beginning with the sequence of letters entered by the user until either the user has spelled an item name that is not available or the user selects one of the short-listed item names;
(iii)(e) if the user selects a short-listed item name, accessing the stored data to select data for a respective one of said plurality of paths that extends between said installed location an item location of the item whose name has been selected;
(iii)(f) combining the data representing said selected path with the data representing the floor plan or layout; and
(iii)(g) causing the touch-sensitive input-output display unit to display said floor plan or layout with the selected path superimposed or overlaid upon the floor plan or layout.

2. An item finder according to claim 1, wherein the item locations are identified as shelf sections, floor areas, or other general locations which may be shared by several different items.

3. An item finder system according to claim 1, wherein the stored data comprises the names of the items and, associated with each item, an identifier corresponding to the item location within the storage region where that item should be found.

4. An item finder according to claim 3, wherein the associated identifier comprises a link to an image file to be used to generate the path between the installed location and the item location associated with that item.

5. An item finder according to claim 4, wherein the storage means groups the item names according to item location, there being for each item location a list of names of items in that item location.

6. An item finder according to claim 4, wherein the storage means stores, selects and displays the item names in alphabetical order.

7. An item finder according to claim 1, wherein the touch-sensitive input-output display unit, the data storage means and the processing means are housed in the same housing.

8. An item finder according to claim 1, further comprising a communications port for communicating with remote data storage means to access at least some of said stored data.

9. An item finder according to claim 1, further comprising a communications port for communicating with a remote external computer to enable updating of data stored on the item finder storage means and extraction of data stored in response to user inputs, for example names of items not found by the user.

10. An item finder according to claim 9, wherein the communications port is adapted to connect to a network, for example the Internet, wireless connection port.

11. An item finder according to claim 1, configured for mounting upon a shelf, bracket or other convenient support within the storage region, conveniently at the beginning of an aisle between shelves or along an aisle.

12. An item finder according to claim 1, comprising a tablet computer, notebook computer, or other suitably-programmed computing device having a touch-sensitive display screen for input of user instructions and a wired or wireless communications port for communication via a data network.

13. An item finder according to claim 12, wherein the tablet computer, notebook computer, or other suitably-programmed computing device has installed remote access software enabling data representing items sought unsuccessfully by customers to be identified and the list of items and their locations updated if and when the unsuccessfully sought items have been added to inventory.

14. An item finder according to claim 1, wherein the location of an item in the store is shown relative to a floor plan or layout of the store by means of a marker symbol, said marker symbol having a shape of a circle or a shape of an arrow or another distinctive shape, or by means of a highlighted section of shelf space.

15. An item finder according to claim 1, wherein the location of an item in the store is shown relative to the floor plan or layout of the store by means of a line that extends from a point that is identified as the shopper's present position relative to the floor plan or layout of the store to a point on the floor plan or layout where the item is situated.

16. An item finder according to claim 1, having means for changing the stored data by means of a computer situated externally to the item finder using a wired or wireless data connection for transferring computer data from the external computer to the item finder or by means of a remote computer connection via the Internet and an Internet connection to a modem, said modem having capability to transfer computer data from the said internet connection to the item finder system by means of a wired or wireless connection.

17. A method of finding items in a store, especially in a retail store, using a computing device having a touch-sensitive input-output display unit (12), either or both of means for storing data locally and means for accessing remote data storage means storing data, and processing means, the stored data representing:
(ii)(a) a floor plan or layout (40) of at least part of the storage region,
(ii)(b) a listing of names of items stored in the storage region associated with their respective item locations in the storage region,
(ii)(c) a predetermined installed location of the touch-sensitive input-output display unit itself, and
(ii)(d) a plurality of paths each extending between the installed location and a respective one of the item locations;
the method comprising the steps, by the processor, of:
(iii) controlling the touch-sensitive input-output display unit to display an input screen to prompt the user to touch the pattern of letters to enter at least one letter to begin spelling the name of the item sought;
(iii)(b) detecting entry of said letter by the user and, in response, using the detected letter to access the stored data to select a shortlist (28) of item names each beginning with that letter and displaying said shortlist on the screen;
(iii)(c) detecting whether the user inputs one or more additional letters or selects one of the short listed item names by touching a specified area of the screen,
(iii)(d) if the user subsequently enters one or more additional letters and the total letters do not spell the item name, as each letter is entered, using the letter to access the stored data and select a revised shortlist of item names each beginning with the sequence of letters entered by the user and displaying the revised shortlist;
(iii)(e) detecting whether or not the user has spelled an item name that is not available or the user has selected one of the short-listed item names by touching the screen;
(iii)(f) if the user selected a short-listed item name, accessing the stored data to select data for a respective one of said plurality of paths that extends between said installed location and said item location of the item whose name has been selected;
(iii)(g) combining the data representing said selected path with the data representing the floor plan or layout; and
(iii)(h) causing the touch-sensitive input-output display unit to display said floor plan or layout with the selected path superimposed or overlaid upon the floor plan or layout.

18. A method according to claim 17, wherein, if step (iii)(e) detects that the user had spelled the name of an item which was not available, the item name is stored in the storage means with an indication that it was sought by a user unsuccessfully.

19. A method according to claim 18, further comprising the step of identifying if and when an unavailable item has been made available in the storage region and adding the previously-unavailable item to the list of item names.

20. A method according to claim 19, further comprising the prior step of preparing the item finder for use by entering into the data storage means the installed location of the item finder with reference to the floor plan or layout and data for generating a unique set of paths each beginning at the installed location and ending at a respective one of the item locations.
